(19) United States
(12) Patent Application Publication
(10) Pub. No.: US 2010/0224564 A1
(43) Pub. Date: Sep. 9, 2010

(54) METHOD FOR REMOVING ORGANIC CONTAMINANTS FROM RESINS

(75) Inventor: Lee L. Shafer, Big Piney, WY (US)

Correspondence Address: MERCHANT & GOULD PC, P.O. BOX 2903, MINNEAPOLIS, MN, 55402-0903, US

(73) Assignee: Anticline Disposal, LLC, Boulder, WY (US)

(21) Appl. No.: 12/715,039

(22) Filed: Mar. 1, 2010

Related U.S. Application Data
(60) Provisional application No. 61/157,286, filed on Mar. 4, 2009.

(51) Int. Cl. B01J 20/34; C02F 1/28; B01D 15/26

(52) U.S. Cl. 210/662; 210/673

(57) ABSTRACT

The disclosure describes a novel method for operating a resin treatment system and a novel organic polisher. The method for operating the resin treatment system is efficient and cost effective.

### RELATED APPLICATIONS

This application claims the benefit of U.S. Provisional Application No. 61/157,286, filed Mar. 4, 2009, and entitled “Method for Removing Organic Contaminants from Boron-Selective Resins” which application is hereby incorporated herein by reference.

### INTRODUCTION

Water, especially in the western United States and other arid regions, is a valuable resource. Many oil and natural gas production operations generate, in addition to the desired hydrocarbon products, large quantities of waste water, referred to as “produced water”. Produced water is a type of industrial process waste. Produced water is typically contaminated with significant concentrations of chemicals and substances requiring that it be disposed of or treated before it can be reused or discharged to the environment. Produced water includes natural contaminants that come from the subsurface environment, such as hydrocarbons from the oil- or gas-bearing strata, inorganic salts, and boron. Produced water may also include man-made contaminants, such as drilling mud, “frac flow back water” that includes spent fracturing fluids including polymers and inorganic cross-linking agents, polymer breaking agents, friction reduction chemicals, and artificial lubricants. These contaminants are injected into the wells as part of the drilling and production processes and recovered as contaminants in the produced water.

The main source of boron in brackish surface waters or ground water can be traced to either residuals from waste water treatment plants (mainly borate from detergent formulations), or to leachables from subsurface strata. In seawater sources, the typical boron concentration in the raw water is 4.5 mg/L. In both seawater and brackish waters, boron is usually present as boric acid, which at higher concentrations and temperatures, form polymers. This behavior is very important in the water cycles in pressurized water reactors.

Reverse osmosis (RO) technology used in desalination also removes some boron. Reverse osmosis (RO) technology is sensitive to temperature and pH. Boron removal can be enhanced by replacing one or more RO membrane modules with a resin-based boron removal stage.

The performance of boron-selective resins (BSRs) is less sensitive to pH and temperature than membranes. Currently available, commercial BSRs typically include macroporous cross-linked poly-styrenic resins, functionalized with N-methyl-D-glucamine (NMG), also called 1-amino-1-deoxy-D-glucitol. FIG. 1 illustrates a structure for N-methyl-D-glucamine. The NMG moieties of BSR capture boron via a covalent chemical reaction and an internal coordination complexation, rather than simple ion exchange. Over a wide range of pH, boric acid “adds” across one of the cis-diol pairs of the functional group to form this relatively stable cis-diol borate ester complex. FIG. 2 illustrates the structure of such an ester complex.

While BSRs may possess as much as 0.9 moles of NMG per liter of resin volume, their operating capacities for boron are typically somewhat lower. Usable operating capacity depends strongly on the concentration of boron in the feed, the operational flow rate, the efficiency of regeneration, and the outlet boron concentration cut-off limit.

In a boron removal process, once the BSR is no longer loading boron, NMG is regenerated, typically in a 2-stage elution/regeneration treatment process employing acid (i.e. sulfuric acid or hydrochloric acid) for elution of the boron. The polymer-bound cis-diol borate ester complex, described above, is subsequently hydrolyzed and the boron eluted from the resin via an acid rinse (the exact reverse of the loading reaction). This boron liberating hydrolysis is relatively facile at pH less than about 1.0; therefore, relatively high concentrations of acid are required for the complete and rapid elution of the boric acid from BSR. The resin is then treated with base, (i.e. sodium hydroxide) to return the conjugate acid salt of the amino-glucamine functionality, back to its free base form. This neutralization is typically followed by water rinse to remove excess hydroxide subsequent to another boron loading cycle.

### SUMMARY

The disclosure describes a novel method for operating a resin treatment system and a novel organic polisher. The method for operating the resin treatment system is efficient and cost effective.

In part, this disclosure describes a method for operating a resin treatment system. The method includes performing the following steps:

a) passing water containing contaminants including at least one organic contaminant and at least one metal through the resin treatment system thereby producing a treated effluent;

b) monitoring one or more parameters related to a concentration of the contaminants in the water and the treated effluent;

c) based on results of the monitoring operation, selecting one of an organic regeneration process and a metal regeneration process, wherein the organic regeneration process and the metal regeneration process are different; and

d) regenerating resin in the resin treatment system via the selected one of the organic regeneration process and the metal regeneration process.

Yet another aspect of this disclosure describes a method for operating a resin treatment system. The method includes performing the following steps:

a) treating contaminated water with a boron-selective resin treatment system;

b) determining that a boron-selective resin is at least partially loaded with organic contaminants; and

c) performing an organic regeneration process, the organic regeneration process comprises,
1) washing the resin with a base to remove the organic contaminants from the resin to produce a regenerated resin and a composition comprising the base and the removed organic contaminants, and
2) rinsing the regenerated resin with water to remove the excess base to form a rinsed regenerated resin.
   Further, the step of washing the loaded resin with the base is not performed in conjunction with an acid treatment as part of a boron regeneration process.

In yet another aspect, the disclosure describes an organic contaminants polisher that includes: a boron-selective resin; a treatment system containing the boron-selective resin; a base washing system attached to the treatment system, the base washing system is adapted to wash the boron-selective resin with a base to remove organic contaminants; a rinse system attached to the treatment system, the rinse system is adapted to remove the excess base from the boron-selective resin after washing the boron-selective resin with the base; and a controller in communication with the treatment system, the base washing system, and the rinse system, the controller is adapted to determine when to run the base washing system and the rinse system based on the throughput of the organic contaminants through the organic contaminates polisher.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a structure for N-methyl-D-glucamine attached to a styrenic resin;

FIG. 2 illustrates a reaction between N-methyl-D-glucamine and boric acid;

FIG. 3 illustrates a conceptual block diagram of an embodiment of an organic contaminants polisher system according to the principles of the present disclosure;

FIG. 4 illustrates an embodiment of a method for operating a resin treatment system according to the principles of the present disclosure; and

FIG. 5 illustrates an embodiment of a method for removing trace amounts of organic contaminants according to the principles of the present disclosure.

FIG. 6 illustrates a graph of an embodiment showing the amount of total organic carbon found in the caustic and rinse water when a boron-selective resin was washed with 40 g of NaOH per 5 gallons of reverse osmosis permeate.

FIG. 7 illustrates a graph of an embodiment showing the amount of TOC found in the caustic and rinse water when a boron-selective resin was washed with 20 g of NaOH per 5 gallons of reverse osmosis permeate.

FIG. 8 illustrates a graph of an embodiment showing the amount of TOC found in a caustic and rinse water when a boron-selective resin was washed with 10 g and 30 g of NaOH per 5 gallons of reverse osmosis permeate.

FIG. 9 illustrates a graph of an embodiment showing the amount of TOC found in a caustic and rinse water when a boron-selective resin was washed with 10 g and 30 g of NaOH per 5 gallons of reverse osmosis permeate.

FIG. 10 illustrates an embodiment of a method for operating a resin treatment system according to the principles of the present disclosure.

FIG. 11 illustrates an embodiment of a method for operating a resin treatment system according to the principles of the present disclosure.

FIG. 12 illustrates an embodiment of a method for operating a resin treatment system according to the principles of the present disclosure.

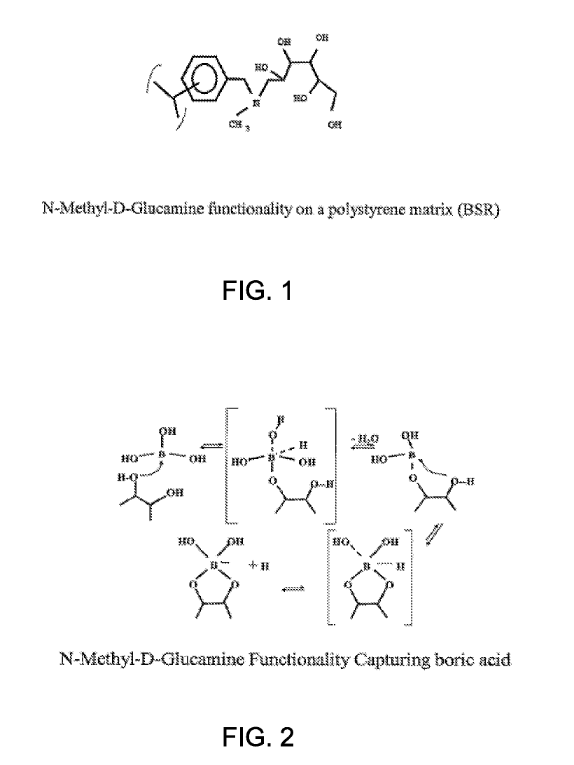

### DETAILED DESCRIPTION

As discussed above, boron-selective resins are utilized for the removal of boron from water. However, in using boron-selective resins for treatment of contaminated water, experiments have determined that the boron-selective resins are also effective at removing organic contaminants and, depending on the relative amounts of organic contaminants and boron in the water, the boron-selective resin may adsorb organic contaminants before a full loading of boron has been achieved. The organic contaminants are adsorbed into the resin so quickly that the removal of boron by the resin may or may not be impaired.

One method of resolving this issue is pre-treating the contaminated water to remove organic contaminants prior to treating the water with boron-selective resins. However, in experiments it was determined that in some cases trace amounts of organic contaminants are still present in the contaminated water even after it is treated to such an extent that organic contaminants are no longer detectable in the water (e.g., the concentrations are below the detection limits of approved test methods and equipment). Activated charcoal may be utilized to remove the trace amounts of organic contaminants. However, the utilization of activated charcoal requires extra processing steps increasing processing times and costs. As used herein “trace amounts of organic contaminants” refers to concentrations equal to or less than 5 milligrams per liter. As used herein “contaminated water” refers to water that contains trace amounts of organic contaminants. The contaminated water may also contain a metal, such as boron. The trace amounts of organic contaminants are adsorbed by a resin, such as a boron-selective resin and may or may not negatively affect the performance of the resin in the removal of the metal, such as boron.

One aspect of the present disclosure relates to a method for operating a boron-selective resin system to remove both boron and also as an organic carbon polisher or a post-treatment organic carbon removal process. Using the methods described herein, the boron-selective resin system may be cost-effectively utilized to simultaneously remove trace organic contaminants, such as hydrocarbons and boron. Another aspect of the present disclosure relates to a novel organic contaminants polisher.

The methods described in this disclosure provide for a cost efficient organic contaminants polisher because the boron-selective resin may remove all or substantially all of the trace amounts of organic contaminants and may be regenerated without utilizing the expensive 2-stage elution/regeneration process required for removing boron from the resin. It has been determined that, even when treating water with very low levels of organics, the resin can become so loaded with organic contaminants that its ability to remove boron may or may not be impaired even though the resin is not yet fully loaded with boron. In addition, when the resin is this loaded with organic contaminants, there is a risk that significant amounts of organic contaminants may periodically desorb from the resin, thereby causing a pulse of effluent having a concentration of organic contaminants higher than that in the influent. In one embodiment, boron-selective resin may be regenerated by a simple washing or flushing with caustic or a regenerating base that removes the adsorbed organic contaminants. The boron-selective resin's efficiency for removing more boron may be improved after the cost efficient and simple washing or flushing with caustic reducing the need to utilize the expensive two-stage elution/regeneration treatment process. Accordingly, this method may achieve a more efficient boron removal over the long term at lower cost than a system that only utilizes a 2-stage elution/regeneration treatment process. Further, this method eliminates the need to utilize an extra treatment process to remove the trace amounts of organic contaminants, such as treating the contaminated stream with activated charcoal prior to treating it with the resin. Therefore, the method provides for a more efficient and cost effective system for the removal of trace amounts of organic contaminates and/or boron.

Without being bound to a particular theory, it is believed that if the boron-selective resin is not rinsed or washed in caustic, the boron-selective resin will adsorb the trace amounts of organic contaminants until large amounts of organic contaminants are adsorbed into the resin. When the resin reaches a saturation level, large amounts of organic contaminants may wash or elute off of the resin resulting in periodic episodes in which the effluent exhibits high concentrations of organic contaminants. The rinsing with base, such as caustic, safely removes the adsorbed organic contaminants from the resin. This rinsing may improve the resin's effectiveness at removing boron, may increase the amount of time between the more expensive boron regeneration cycles, and/or eliminates the need to utilize extra steps to remove the trace amounts of organic contaminants.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the scope of the equipment and methods described herein.

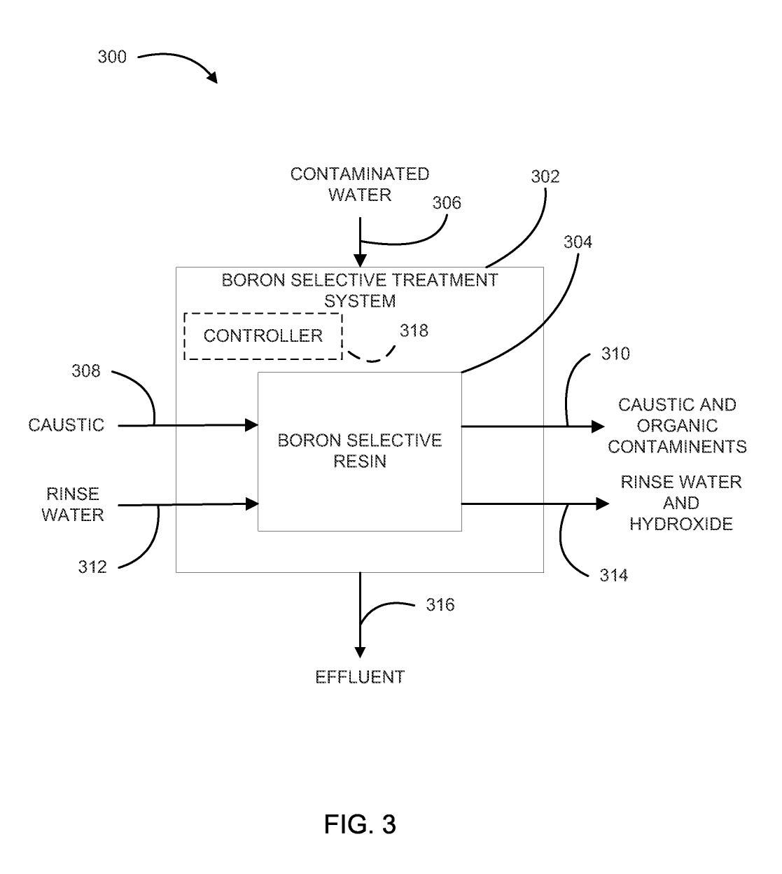

FIG. 3 illustrates a conceptual block diagram of an embodiment of an organic contaminants polisher system 300. The organic contaminants polisher system 300 may be utilized to remove trace amounts of organic contaminants from contaminated water 306. The contaminated water 306 may be produced water or effluent from a water treatment system that includes trace amounts of organic contaminants. The contaminated water 306 may also include a metal, such as boron. The organic contaminants polisher system 300 may also be utilized to remove the metal from the contaminated water 306. The organic contaminants polisher system 300 includes a resin treatment system 302 having an ion-exchange resin 304, such as a boron-selective resin. FIG. 3 illustrates an embodiment where the resin treatment system 302 is a boron-selective resin treatment system 302 that utilizes a boron-selective resin 304 to remove boron from water contaminated with organic contaminants.

The boron-selective resin 304 may be any resin 304 suitable for removing trace amounts of organic containments and/or or boron. In one embodiment, the boron-selective resin 304 is a boron-selective M-methyl-D-glucamine functional resin. In another embodiment, the resin 304 is DOWEX™ BSR-1, a uniform particle size weak base anion exchange resin for selective boron removal, owned and sold by the Dow Chemical Company. In a further embodiment, the resin 304 is selected from the group of DOWEX™ BSR-1, DOWEX™ M-43, DOWEX 21K XLT, and DOWEX MARATHON™ MSA, which are all owned and sold by the Dow Chemical Company.

In another embodiment, the treatment system utilizes an ion-exchange resin. In one embodiment, the ion-exchange resin is selected to pull a metal contaminant other than boron from the contaminated water. In an additional embodiment, the ion-exchange resin is selected to pull a plurality of metals from contaminated water. In another embodiment, the resin is a chelation resin. In one embodiment, the chelation resin is suitable for removing at least one metal from contaminated water, such as lead, boron, copper, zinc, aluminum, cadmium, nickel, cobalt, magnesium, barium, strontium, iron, and mercury. In one embodiment, the chelation resin is selected from the group of Purolite® S110, Purolite® S108, Purolite® S910, and Purolite® S985, which are all owned and sold by The Purolite Company.

In one embodiment, the organic contaminants polisher system 300 may be a portion of a multiunit waste treatment system, such as the one disclosed in U.S. application Ser. No. 11/685,663, published on Mar. 6, 2008 (Publication No. 2008/0053896) which is hereby incorporated herein by reference.

Contaminated water 306 is fed into the organic polisher system 300. The organic contaminants polisher system 300 may include any suitable equipment for running or operating a resin-based removal process, such as a packed bed column, a fluidized bed reactor, a resin column, and/or a recirculation tank. Further the organic contaminants polisher system 300 may include any suitable equipment for running or operating a polisher system for removing organic contaminants from contaminated water 306.

The boron-selective resin 304 in the boron-selective treatment system 302 adsorbs trace amounts of organic contaminants from the contaminated water 306. The boron-selective treatment system 302 releases an effluent 316 that is free of organic contaminants. As used herein “free of organic contaminants” refers to a concentration of organic contaminants that is equal to or less than 0.10 milligrams per liter. In one embodiment, the effluent 316 is further free of boron or substantially free of boron. As used herein the term “substantially free of boron” refers to a concentration of boron that is equal to or less than 1 milligram per liter.

The boron-selective resin 304 is only capable of removing a certain amount of organic contaminants and/or boron before the resin becomes fully loaded and must be regenerated. Once the boron-selective resin 304 has removed this amount of either contaminant (which may be detected by a rise in the organic contaminant and/or boron concentrations in the effluent 316), the performance of the resin is impacted. For example, continued treatment with the resin 304 may result in the organic contaminants leaking off causing a spike in organic contaminant concentration, or the concentrations of contaminants may rise causing the system to no longer effectively treat the contaminated water to a specified standard.

When the boron-selective resin 304 is loaded with organic contaminants but not fully loaded with boron, the boron-selective resin 304 can be regenerated by washing the resin 304 with caustic 308 and then rinse water 312. This will be referred to as an organic regeneration process to differentiate it from the more-involved and expensive boron regeneration removal process necessary to remove boron from the resin.

Any suitable amount of base, such as caustic 308, for removing organic contaminants to regenerate the resin 304 may be utilized in the organic regeneration process. In one embodiment, the resin is washed with 10 grams to 40 grams of base for every 5 gallons of reverse osmosis permeate with pilot testing indicating that 20 grams to 40 grams per 5 gallons had approximately the same organic contaminant removal efficiency. In one embodiment, the base utilized was caustic. In another embodiment, the base is hydroxide.

Any suitable amount of rinse water 312 for removing excess base, such as hydroxide, may be utilized in the organic regeneration process, such as 15 to 20 gallons of rinse water. After rinsing the resin to remove the excess hydroxide, a rinse water and base, such as a hydroxide composition 314 is produced. A base wash system, such as a caustic wash system, may be utilized to wash the resin 304 with caustic 308 and rinse water 312.

In one embodiment, the organic contaminants polisher system 300 stops feeding contaminated water 306 into the boron-selective treatment system 302 once the boron-selective resin 304 is determined to be so loaded as to reduce its performance to an unacceptable level. The organic contaminants polisher system 300 may then wash the boron-selective resin 304 with caustic 308 followed with rinse water 312. The caustic 308 removes the organic contaminants from the boron-selective resin 304 and produces a composition comprising caustic 308 and organic contaminants 310. This has been found to return the boron-selective resin to a condition that allows the effective removal of boron when the resin is not otherwise fully loaded with boron. The boron-selective resin 304 then may be placed back in service treating the contaminated water.

Depending on the relative amounts of organic contaminants and boron in the contaminated water, the organic regeneration process may be repeated multiple times before a boron regeneration process must be performed to remove boron from the resin. Again, determination of when to perform a boron regeneration process may be based on monitoring the boron in the effluent 316, a mass balance or other tracking of the amount of boron being provided to the resin over time based on boron concentrations in the contaminated water 306, or any other suitable technique. The monitoring and/or tracking of the amount of boron or organic contaminants in the effluent can be measured in any suitable way, such as with an automatic and/or computerized monitor or with periodic manual batch sample testing.

In one embodiment, the organic contaminants polisher system 300 further includes an organic contaminants monitor system. The organic contaminants monitor system is attached to the treatment system and in communication with controller 318. The organic contaminants monitor system may be located inside of the treatment system 302 or be a separate independent component from treatment system 302. In an embodiment, the organic contaminants monitor system monitors an amount of the organic contaminants fed into the organic contaminants polisher. Further, in another embodiment, the organic contaminants monitor system monitors the amount organic contaminants in the effluent released from the organic contaminants polisher.

In a further embodiment, the organic contaminants polisher system 300 further includes a controller 318. The controller 318 may be located inside of the treatment system 302 or may be a separate independent component from treatment system 302. The controller 318 is in communication with the treatment system, the base washing system, and the rinse system. The controller 318 determines when to run the base washing system and the rinse system based on the throughput of the organic contaminants through the organic contaminates polisher. In one embodiment, the controller 318 determines the throughput of organic contaminants based on information gathered by the organic contaminants monitor system.

In embodiments in which the boron-selective resin is used to treat contaminated water that is substantially free of boron, i.e., as an organic contaminant polisher, a boron regeneration operation may be performed periodically in order to remove trace amounts of boron or other contaminants that build up on the resin but that are not removed by the organic regeneration process.

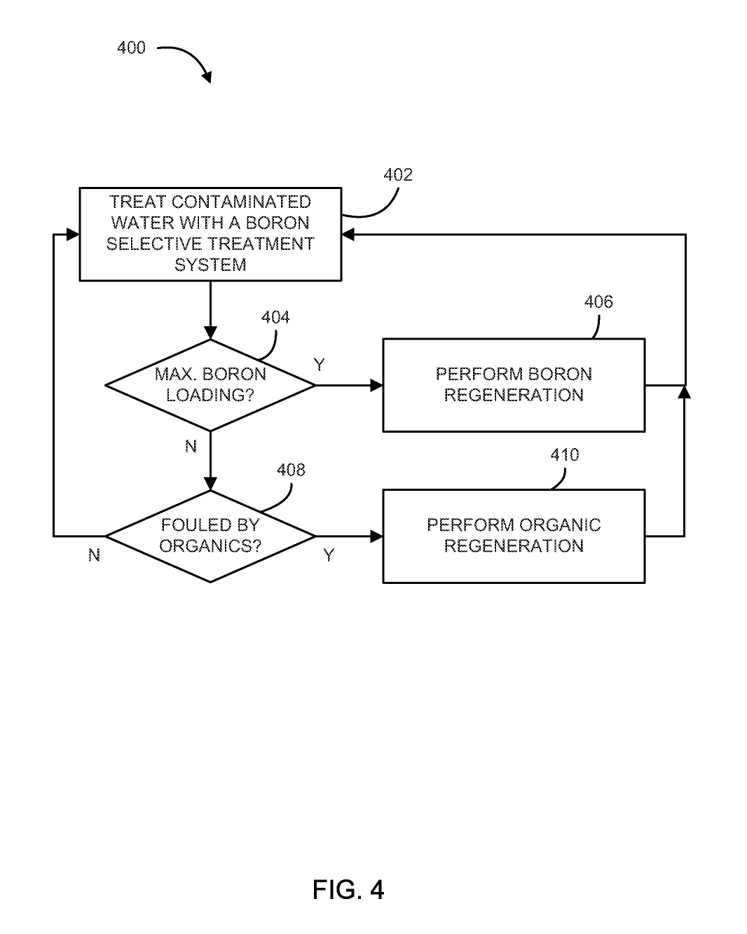

FIG. 4 illustrates an embodiment of a method for operating a resin treatment system 400. Method 400 is suitable for the simultaneous removal of organic contaminates and boron from a contaminated water stream. As illustrated, method 400 starts with a treatment operation 402 in which contaminated water is passed through a bed of boron-selective resin. The contaminated water may contain boron and/or organic contaminants. The organic contaminants and/or boron are removed from the water stream by the treatment operation 402.

During the treatment operation 402, the performance of the system may be monitored and/or the amount of organic contaminants and boron removed by the resin may be identified. From this information, several ongoing tests (illustrated by two decision operations 404, 408) are performed.

The method 400 includes a first determination operation 404 that determines if the boron-selective resin has become sufficiently loaded with boron to merit a regeneration of the resin. As discussed above, this determination may be made based on one or more of multiple factors including the concentration of boron in the treated effluent, the amount of boron that has been provided to the treatment system since the last boron regeneration cycle, or any other suitable metric selected by the operator.

Upon determination that the boron-selective resin is at least partially loaded with boron, a boron regeneration process 406 is performed. In an alternative embodiment, upon determination that the boron-selective resin is substantially loaded with boron, a boron regeneration process 406 is performed. In one embodiment, this operation 406 includes a two-stage elution/regeneration treatment process. The two-stage elution/regeneration treatment process employs acid (i.e. sulfuric or hydrochloric acid) for elution of the boron. The polymer-bound cis-diol borate ester complex, described above, is subsequently hydrolyzed and the boron eluted from the resin via an acid rinse (the exact reverse of the loading reaction). This boron liberating hydrolysis is relatively facile at pH less than about 1.0; therefore, relatively high concentrations of acid are required for the complete and rapid elution of the boric acid from boron-selective resin. The resin is then treated with base, (i.e. sodium hydroxide) to return the conjugate acid salt of the amino-glucamine functionality, back to its free base form. This neutralization is typically followed by water rinse to remove excess regenerative base, such as hydroxide, subsequent to another boron loading cycle. The two-stage elution/regeneration treatment process creates a rejuvenated or regenerated base suitable for removing at least one of boron or organic contaminants from the boron-selective resin.

Method 400 includes a second determination operation 408. The second determination operation 408 may be performed independent of determination operation 404 or in conjunction with determination operation 404. In one embodiment, determination operation 408 is performed when it is determined that the resin is not or should not be sufficiently loaded with boron to warrant a boron regeneration process 406. The second determination operation 408 determines if the boron-selective resin has become at least partially loaded with organic contaminants to merit regeneration of the resin. In another embodiment, the second determination operation 408 determines if the boron-selective resin has become fully loaded with organic contaminants to merit regeneration of the resin. In yet another embodiment, determination operation 408 determines that a boron-selective resin is substantially loaded and is at least partially loaded with organic contaminants.

As discussed above, this determination may be made based on one or more of multiple factors such as a comparison of the boron removal efficiency to the expected current boron load on the resin and any suitable metric selected by the operator may be used. In one embodiment, an operator may monitor the amount of organic contaminants passed into the treatment system, since the last organic regeneration 410 in addition to the monitoring of the treatment performance by monitoring contaminants in the effluent. Based on a comparison of the amount of organic contaminants passed into the system, the amount of resin in the treatment unit, and the observed quality of the water exiting the system, determinations may be made that performance has dropped even though the amount of organic contaminant input is less than that which should fully load the resin.

In an alternative embodiment or in addition to the above embodiment, an operator may monitor the amount of boron passed into the treatment system since the last boron regeneration 406 in addition to the monitoring of the treatment performance by monitoring contaminants in the effluent. Based on a comparison of the amount of boron passed into the system, the amount of resin in the treatment unit, and the observed quality of the water exiting the system, [such as the organic contaminant leakage], determinations may be made that performance has dropped even though the amount of boron input is less than that which should fully load the resin. Given these observations, it may be assumed that the resin has become at least partially loaded with organic contaminants and that an organic regeneration operation 410 should be performed.

When it is determined that the boron-selective resin is at least partially loaded with organic contaminants, an organic regeneration operation 410 is performed. In this operation 410, the loaded resin is washed with caustic or any suitable base followed by rinse water. The caustic removes the organic contaminants from the boron-selective resin to regenerate the resin. The amount of washing with the basic solution may be fixed or may be varied to ensure that as much organics as possible have been removed. For example, in an embodiment the concentration of organic contaminants in the basic wash exiting the system is monitored and the basic wash is continued until the concentration of organic contaminants falls to some acceptable level. The rinse water removes excess caustic from the regenerated resin. In an embodiment, the amount of rinse water used is that sufficient to return the pH of the resin bed to an acceptable level before placing the resin back into service.

In the embodiment of the method 400 shown, the determination operations 404, 408 may be considered collectively to constitute an ongoing monitoring and testing operation that either continuously or periodically evaluates the system to determine when to perform the different regeneration operations 406, 410.

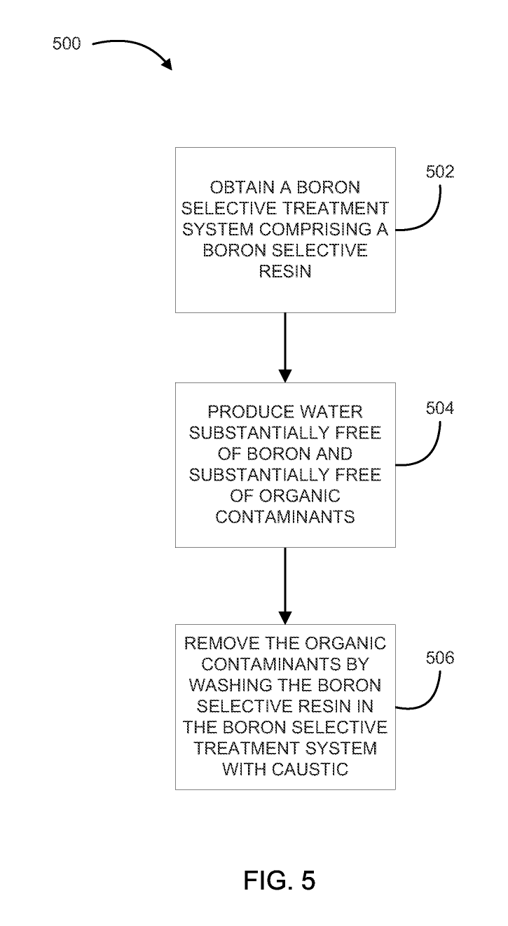

FIG. 5 illustrates an embodiment of a method for removing trace amounts of organic contaminants from a boron-selective resin 500. Method 500 obtains a boron-selective treatment system comprising a boron-selective resin, 502. Method 500 feeds contaminated water into the boron-selective treatment system to produce water substantially free of boron and substantially free of organic contaminants, 504. Method 500 removes the organic contaminants by washing the boron-selective resin in the boron-selective treatment system with caustic, 506.

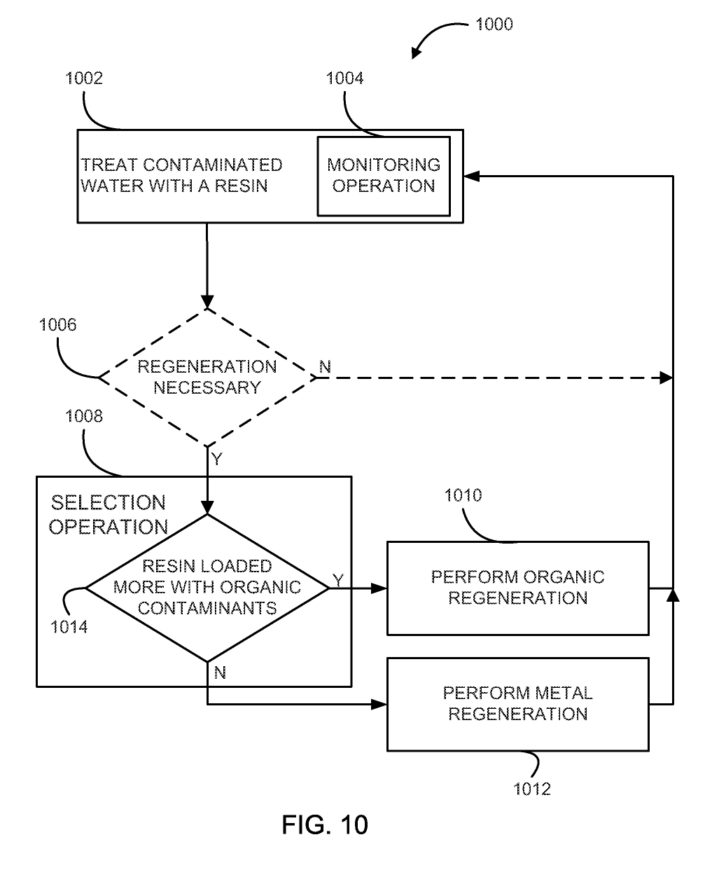

FIGS. 10, 11, and 12 illustrate different embodiments of a method for operating a resin treatment system 1000.

As illustrated, method 1000 has a treatment operation 1002. Treatment operation 1002 passes water containing contaminants including at least one organic contaminant and at least one metal through a resin treatment system to produce a treated effluent. In one embodiment, the at least one organic contaminant is organic carbon. In another embodiment, the at least one metal is boron. In a further embodiment, the at least one metal is selected from the group of lead, copper, boron, zinc, aluminum, cadmium, nickel, cobalt, magnesium, barium, strontium, iron, and mercury. In one embodiment, the water is produced water.

The resin utilized in treatment operation 1002 is an ion-exchange resin. In one embodiment, the resin utilized in the treatment operation 1002 is a chelation resin. In another embodiment, the resin utilized in the in the treatment operation 1002 is a boron-selective resin.

In an additional embodiment, method 1000 produces a treated effluent substantially free of the at least one organic contaminant. In another embodiment, method 1000 produces treated effluent that is substantially free of the at least one metal. In an alternative embodiment, method 1000 produces a treated effluent that is substantially free of the at least one metal and the at least one organic contaminant.

As illustrated in FIGS. 10-12 the treatment operation further comprises a monitoring operation 1004. Monitoring operation 1004 monitors one or more parameters related to a concentration of the contaminants in the water and the treated effluent. In one embodiment, monitoring operation 1004 includes measuring one or more of a concentration of the at least one organic contaminant in the water, a concentration of the at least one organic contaminant in the treated effluent, a concentration of the at least one metal in the water and a concentration of the at least one metal in the treated effluent.

Based on results of the monitoring operation, a selection operation 1008 is performed. The selection operation 1008 selects one of an organic regeneration process 1010 and a metal regeneration process 1012 based on the results of the monitoring operation. Next, method 1000 regenerates the resin in the resin treatment system via the selected one of the organic regeneration process 1010 and the metal regeneration process 1012.

The organic regeneration process 1010 includes washing the resin with a base to remove the at least one organic contaminant from the resin to produce a regenerated resin and a composition comprising the base and the removed at least one organic contaminant and rinsing the regenerated resin to remove the excess base from the regenerated resin. In one embodiment, the base is caustic. In another embodiment, the base is hydroxide. The performance of the organic regeneration process 1010 provides the regenerated resin. The regenerated resin is suitable for removing the at least one organic contaminant and/or the at least one metal from the water.

The metal regeneration process 1012 includes washing the resin with acid for elution of the at least one metal from the resin and treating the resin with a base after the step of washing the resin with acid to neutralize the resin. In one embodiment, the base is caustic. In another embodiment, the base is hydroxide. The performance of the metal regeneration process provides the regenerated resin. The regenerated resin is suitable for removing the at least one organic contaminant and/or the at least one metal from the water.

The organic regeneration process 1010 is performed to remove the at least one organic contaminant from the resin and only includes a base wash step and a rinsing step. The metal regeneration process 1012 is performed to remove the at least one metal from the resin and includes an acid wash step followed by a base rinse step. While both processes wash the resin with base, the base wash step in process 1010 removes the at least one organic contaminant from the resin. The base rinse step in process 1012 reacts with the acid in the acid rinse previously added to the resin to neutralize the acid. No acid is utilized in process 1010. Accordingly, the organic regeneration process 1010 and the metal regeneration process 1012 are different.

Selection operation 1008 includes at least one determination step. In one embodiment, selection operation 1008 includes a determination operation 1014 that determines, based on the results of the monitoring operation, if the resin is relatively more loaded with the at least one organic contaminant than the at least one metal, as illustrated in FIG. 10. If the determination operation 1014 determines that the resin is relatively more loaded with the at least one organic contaminant than the at least one metal, determination operation 1014 selects to perform the organic regeneration process 1010. If the determination operation 1014 determines that the resin is not relatively more loaded with the at least one organic contaminant than the at least one metal, determination operation 1014 selects to perform the metal regeneration process 1012.

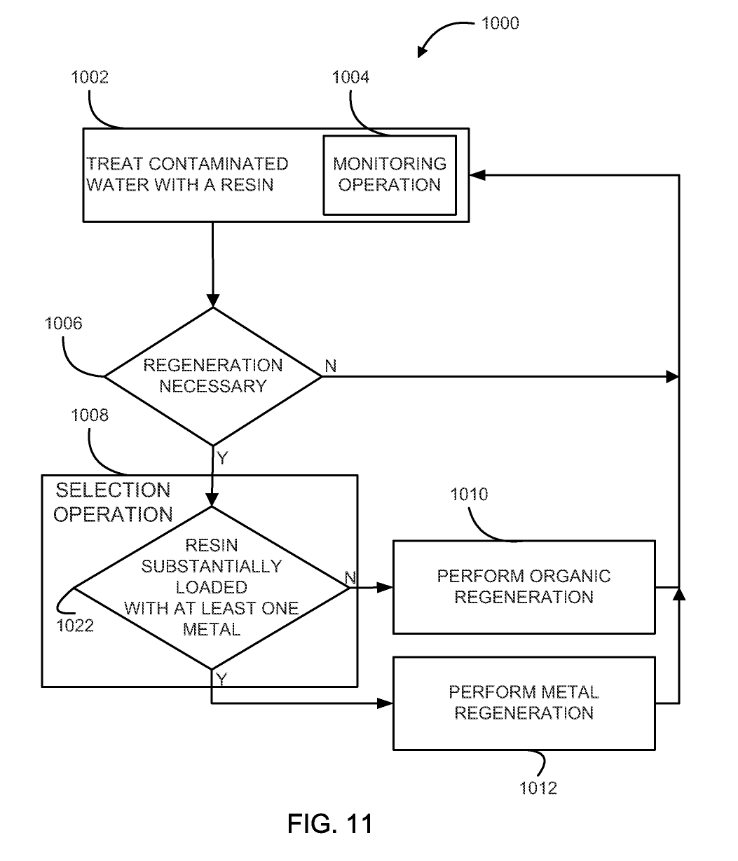

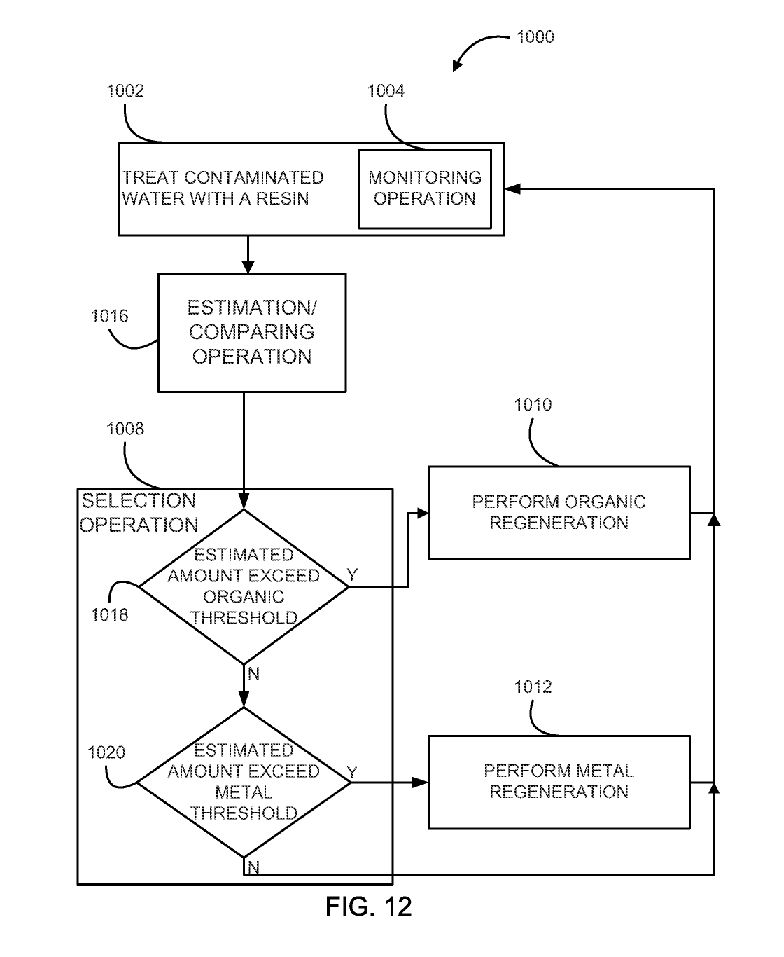

In one embodiment, method 1000 further includes a determination operation 1006 prior to the selection operation 1008, as illustrated in FIGS. 10 and 11. Determination operation 1006, determines, based on the results of the monitoring operation, if a regeneration of the resin should be performed. If the determination operation 1006 determines that the regeneration of the resin should be performed, method 1000 performs the selection operation 1008. If the determination operation 1006 determines that the regeneration of the resin should not be performed, method 1000 continues the treatment operation 1002 without regenerating the resin.

In another embodiment, selection operation 1008 includes a determination operation 1022 that determines, based on the results of the monitoring operation, if the resin is substantially loaded with the at least one metal, as illustrated in FIG. 11. If the determination operation 1022 determines that the resin is substantially loaded with the at least one metal, determination operation 1022 selects to perform the metal regeneration process 1012. If the determination operation 1022 determines that the resin is not substantially loaded with the at least one metal, determination operation 1022 selects to perform the organic regeneration process 1010. As used herein, the term “substantially loaded” refers to a resin that has been loaded with an amount of metal that makes it desirable for the operator of the treatment system to run the metal regeneration process. In one embodiment, a resin is substantially loaded if the resin is more than 50% loaded with metal. In another embodiment, a resin is substantially loaded if the resin is more than 75% loaded with metal. In a further embodiment, a resin is substantially loaded if the resin is more than 90% loaded with metal.

In yet another embodiment, the selection operation 1008 includes at least one determination operation and an estimation/comparing operation 1016, as illustrated in FIG. 12. Estimation/comparing operation 1016 estimates at least one of an amount of the at least one organic contaminant removed by the resin treatment system since a prior regeneration and an amount of the at least one metal removed by the resin treatment system since a prior regeneration. In one embodiment, estimation/comparing operation 1016 utilizes information gathered by monitoring operation 1004, such as the one or more monitored parameters related to a concentration of the contaminants in the water and the treated effluent. In another embodiment, estimation/comparing operation 1016 utilizes the one or more of a concentration of the at least one organic contaminant in the water, a concentration of the at least one organic contaminant in the treated effluent, a concentration of the at least one metal in the water and a concentration of the at least one metal in the treated effluent measured by the monitoring operation 1004. Next, in this embodiment, estimation/comparing operation 1016 compares the estimated amount to a predetermined threshold. As utilized herein, the “predetermined threshold” is an amount that is determined or selected by the operator of the treatment system based on at least one of the amount of contaminants being fed into the treatment system, the capacity of the resin, cost of the metal regeneration process and/or the organic regeneration process, and resin efficiency at each capacity.

In one embodiment, estimation/comparing operation 1016 estimates the amount of the at least one organic contaminant removed by the resin. In another embodiment, estimation/comparing operation 1016 estimates the amount of the at least one metal removed by the resin. In yet another embodiment, estimation/comparing operation 1016 estimates the at least one metal and the at least one organic contaminant removed by the resin. Estimation/comparing operation 1016 further compares these estimates to the predetermined thresholds for the at least one organic contaminant and/or the at least one metal.

Based on the results of comparing operation 1016, the selection operation 1008 selects one of the organic regeneration process 1010 and the metal regeneration process 1012. In one aspect of this embodiment, the selection operation 1008 may include two determination operations 1018 and 1020. Determination operation 1018 determines, based on the results of comparing operation 1016, if the estimated amount of the at least one organic contaminant exceeds the predetermined threshold. If the determination operation 1018 determines that the estimated amount of the at least one organic contaminant exceeds the predetermined threshold, determination operation 1018 selects to perform the organic regeneration process 1010. If the determination operation 1018 determines the estimated amount of the at least one organic contaminant does not exceed the predetermined threshold, determination operation 1018 selects to perform determination operation 1020.

Determination operation 1020 determines, based on the results of comparing operation 1016, if the estimated amount of the at least one metal exceeds the predetermined threshold. If the determination operation 1020 determines that the estimated amount of the at least one metal exceeds the predetermined threshold, determination operation 1020 selects to perform the metal regeneration process 1012. If the determination operation 1022 determines that the estimated amount of the at least one metal does not exceed the predetermined threshold, determination operation 1020 selects to continue the treatment operation 1002 without regenerating the resin.

The regenerated resin of method 1000 has had the adsorbed organic contaminants removed from the resin preventing large clumps of organic contaminants from leaking from the resin into the treated effluent. Further, the resin's efficiency for in method 1000 may be improved after performing the organic regeneration process reducing the need to utilize the expensive two-stage metal regeneration process. Further, method 1000 eliminates the need to utilize an extra treatment process to remove the trace amounts of organic contaminants, such as treating the contaminated stream with activated charcoal prior to treating it with the resin. Therefore, method 1000 provides for a more efficient and cost effective system for the removal of trace amounts of organic contaminates and/or metal.

The methods and systems of this invention can be adapted for drinking water processing, agricultural water treatment, sweetener production, waste water processing, mining hydrometallurgy, condensate polishing, and other water treatment uses. Another aspect of this invention is a seawater desalination system comprising a reverse osmosis stage having a low energy membrane and a boron removal stage with a boron-selective resin.

### EXAMPLES

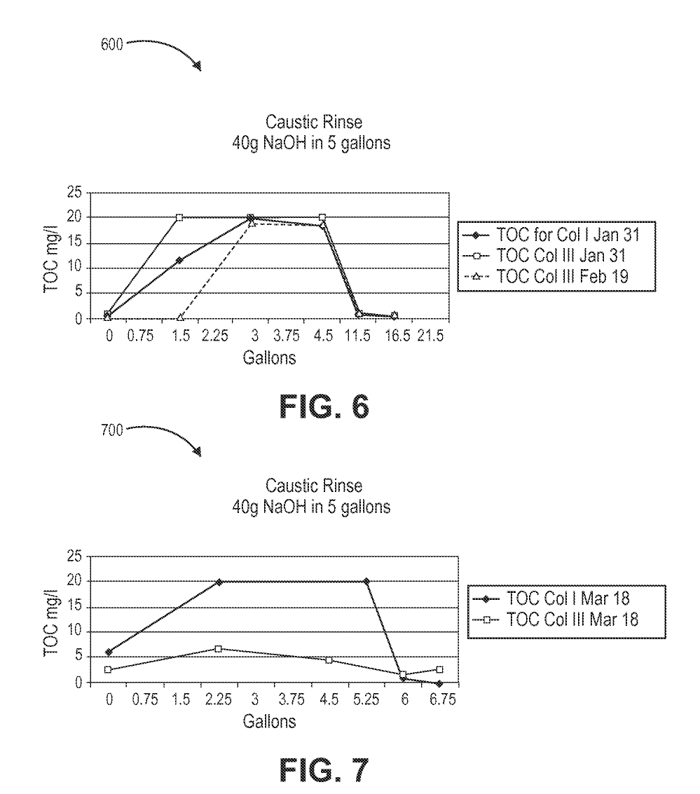

In an embodiment, contaminated water was passed through columns containing boron-selective resins. After the feeding of an amount of contaminated water, organic leakage from the boron resin was detectable prior to fully loading the resin with boron. The boron-selective resins were washed with different concentrations of caustic instead of being put through a full regeneration process to determine if the boron removal efficiency could be improved. FIGS. 6-9 illustrate graphs of the amount of organic contaminants (i.e. organic carbon) removed by the caustic wash. Further, the experiments showed that an amount of organic carbon is adsorbed by the boron-selective resin and can be removed from the boron-selective resin by utilizing a caustic wash.

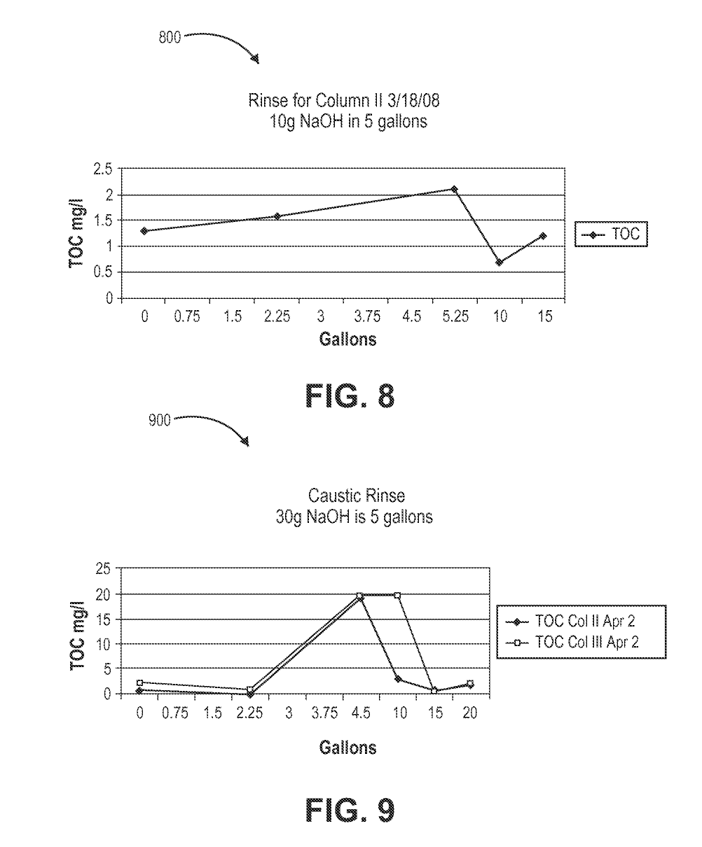

The graphs illustrated in FIGS. 6-9 show the amount of organic contaminants found in the caustic and rinse water as an amount of total organic carbon (TOC) found in the caustic and rinse water after washing the boron-selective resin with different concentrations of caustic and 15 to 20 gallons of rinse water. For instance, FIG. 6 illustrates the amount of TOC found in the caustic and rinse water when the resin was washed with 40 g of NaOH per 5 gallons of reverse osmosis permeate. FIG. 7 illustrates the amount of TOC found in the caustic and rinse water when the resin was washed with 20 g of NaOH per 5 gallons of reverse osmosis permeate. Further, FIGS. 8 and 9 illustrate the amount of TOC found in the caustic and rinse water when the resin was washed with 10 g and 30 g of NaOH per 5 gallons of reverse osmosis permeate.

The graph shown in FIG. 6 illustrates that caustic wash at a concentration of 40 g of NaOH per 5 gallons of reverse osmosis permeate removed TOC from the boron-selective resin. The graph shown in FIG. 7 illustrates that caustic wash at a concentration of 20 g of NaOH per 5 gallons of reverse osmosis permeate removed TOC from the boron-selective resin. The graph shown in FIGS. 8 and 9 illustrate that the caustic wash at concentrations of 10 g and 30 g of NaOH per 5 gallons of reverse osmosis permeate also removed TOC from the boron-selective resin. Therefore, all of the concentrations of caustic utilized were suitable for removing TOC from the boron-selective resin with the higher concentration of caustic showing an increase in removal. These examples are not meant to be restrictive. Accordingly, it is contemplated that other concentrations of caustic and other amounts of wash may be utilized to remove TOC from a boron-selective resin at least partially loaded with organic contaminants.

FIGS. 6-9 illustrate that boron-selective resins in organic contaminants polisher systems adsorb organic contaminants and that washings with caustic remove at least portions of the adsorbed organic contaminants from the boron-selective resins.

The above specification provides a complete description of the present invention. Since many embodiments of the invention can be made without departing from the spirit and scope of the invention, certain aspects of the invention reside in the claims hereinafter appended.

What is claimed is:

1. A method for operating a resin treatment system, comprising:
passing water containing contaminants including at least one organic contaminant and at least one metal through the resin treatment system thereby producing a treated effluent;
monitoring one or more parameters related to a concentration of the contaminants in the water and the treated effluent;
based on results of the monitoring operation, selecting one of an organic regeneration process and a metal regeneration process, wherein the organic regeneration process and the metal regeneration process are different; and
regenerating resin in the resin treatment system via the selected one of the organic regeneration process and the metal regeneration process.

2. The method of claim 1, wherein selecting further comprises:
determining, based on the results of the monitoring operation, that the resin is relatively more loaded with the at least one organic contaminant than the at least one metal; and
selecting the organic regeneration process.

3. The method of claim 1, wherein performing the organic regeneration process comprises:
washing the resin with a base to remove the at least one organic contaminant from the resin thereby producing a regenerated resin and a composition comprising the base and the removed at least one organic contaminant; and
rinsing the regenerated resin to remove the excess base from the regenerated resin.

4. The method of claim 1, wherein performing the metal regeneration process comprises:
washing the resin with acid for elution of the at least one metal from the resin; and
treating the resin with a base after the step of washing the resin with the acid to neutralize the resin.

5. The method of claim 1, wherein monitoring comprises:
measuring one or more of a concentration of the at least one organic contaminant in the water, a concentration of the at least one organic contaminant in the treated effluent, a concentration of the at least one metal in the water and a concentration of the at least one metal in the treated effluent.

6. The method of claim 5, wherein selecting further comprises:
estimating at least one of an amount of the at least one organic contaminant removed by the resin treatment system since a prior regeneration and an amount of the at least one metal removed by the resin treatment system since a prior regeneration;
comparing the estimated amount to a predetermined threshold; and
selecting one of the organic regeneration process and the metal regeneration process, based results of the comparing operation.

7. The method of claim 1, further comprising:
determining, based on the results of the monitoring operation, that a regeneration of the resin should be performed.

8. The method of claim 1, wherein selecting further comprises:
determining, based on the results of the monitoring operation, that the resin is substantially loaded with the at least one metal; and
selecting the organic regeneration process.

9. The method of claim 1, wherein the metal regeneration process includes at least part of the organic regeneration process.

10. A method for operating a resin treatment system, comprising:
treating contaminated water with a resin treatment system;
determining that a boron-selective resin is at least partially loaded with organic contaminants;
performing an organic regeneration process, the organic regeneration process comprises,
washing the resin with a base to remove the organic contaminants from the resin to produce a regenerated resin and a composition comprising the base and the removed organic contaminants and
rinsing the regenerated resin with water to remove the excess base to form a rinsed regenerated resin,
wherein the step of washing the loaded resin with the base is not performed in conjunction with an acid treatment as part of a boron regeneration process.

11. The method of claim 10, further comprises:
determining that the boron-selective resin is at least partially loaded with boron; and
performing the boron regeneration process.

12. The method of claim 11, wherein the boron regeneration process comprises:
washing the resin with an acid for elution of the boron from the resin, and
treating the resin with a regenerative base after the step of washing the resin with the acid to neutralize the resin forming a rejuvenated resin.

13. The method of claim 10, further comprising:
determining that the boron-selective resin is substantially loaded with boron; and
performing the boron regeneration process.

14. The method of claim 13, wherein the boron regeneration process comprises:
washing the resin with acid for elution of the boron from the resin, and
treating the resin with regenerative base after the step of washing the resin with the acid to neutralize the resin forming a rejuvenated resin.

15. The method of claim 10, wherein the contaminated water comprises organic carbon and boron.

16. The method of claim 10, wherein the contaminated water comprises organic carbon and is substantially free of boron.

17. The method of claim 10, wherein the organic contaminants are organic carbon.

18. The method of claim 10, further comprises monitoring the concentration of at least one of the organic contaminants and boron in effluent produced by the resin treatment system.

19. An organic contaminants polisher, comprising:
a boron-selective resin;
a treatment system containing the boron-selective resin;
a base washing system attached to the treatment system, the base washing system is adapted to wash the boron-selective resin with a base to remove organic contaminants;
a rinse system attached to the treatment system, the rinse system is adapted to remove the excess base from the boron-selective resin after washing the boron-selective resin with the base; and
a controller in communication with the treatment system, the base washing system, and the rinse system, the controller is adapted to determine when to run the base washing system and the rinse system based on the throughput of the organic contaminants through the organic contaminates polisher.

20. The organic contaminants polisher of claim 1, further comprising:
an organic contaminants monitor system attached to the treatment system and in communication with controller,
wherein the organic contaminants monitor system is adapted to monitor an amount of the organic contaminants fed into the organic contaminants polisher and an amount organic contaminants in effluent released from the organic contaminants polisher.
